(19) United States
(12) Patent Application Publication
(10) Pub. No.: US 2015/0286312 A1
(43) Pub. Date: Oct. 8, 2015

(54) TOUCH SENSOR

(71) Applicant: SAMSUNG DISPLAY CO., LTD., Yongin-City (KR)

(72) Inventors: SUNG KU KANG, Suwon-si (KR); BYEONG KYU JEON, Busan (KR)

(21) Appl. No.: 14/533,569

(22) Filed: Nov. 5, 2014

(30) Foreign Application Priority Data
Apr. 2, 2014 (KR) 10-2014-0039529

(51) Int. Cl. G06F 3/044; G09G 3/32; G06K 9/00; G09G 3/36

(52) U.S. Cl. CPC G06F 3/044; G09G 3/3611; G09G 3/3208; G06K 9/0002; G09G 2300/0426

(57) ABSTRACT

A touch sensor is provided. The touch sensor includes a substrate and a circular-shaped touch portion provided on the substrate. The touch portion includes a plurality of sensing lines. Cross portions in which the plurality of sensing lines crosses each other are more densely disposed toward the center of the touch portion. The touch portion is configured to recognize a fingerprint.

### CROSS-REFERENCE TO RELATED APPLICATION

This application claims priority under 35 U.S.C. §119 to Korean Patent Application No. 10-2014-0039529, filed on Apr. 2, 2014, in the Korean Intellectual Property Office, the disclosure of which is incorporated by reference herein in its entirety.

### TECHNICAL FIELD The present invention relates to a touch sensor, and more particularly, to a touch sensor that recognizes a fingerprint.

### DISCUSSION OF THE RELATED ART

A touch sensor is a device that recognizes a touch of a stylus or a touch of a user's finger. Touch sensor have been incorporated into display panels such as an organic light emitting diode displays and a liquid crystal display devices.

A touch sensor for recognizing a fingerprint has been developed.

A fingerprint has a pattern having a plurality of protruded portions extended in various curves in a narrow area. A touch sensor may recognize the fingerprint based on a plurality of sensing lines disposed densely on a particular area at the touch sensor.

### SUMMARY

According to an exemplary embodiment of the present invention, a touch sensor is provided. The touch sensor includes a substrate and a circular-shaped touch portion. The touch portion is provided on the substrate. The touch portion includes a plurality of sensing lines. Cross portions in which the plurality of sensing lines crosses each other are more densely disposed toward the center of the touch portion. The touch portion is configured to recognize a fingerprint.

The plurality of sensing lines may include a circularly extended first sensing line and a second sensing line linearly extended in an outer direction from the center of the touch portion. The second sensing line may cross the first sensing line.

The first sensing line may be linearly extended from an outer side of the touch portion and circularly extended at an inner side of the touch portion.

The first sensing line may be provided in plural, and the first sensing lines may be separated from each other and form concentric circles.

The second sensing line may be provided in plural, and the second sensing lines may be separated from each other. The second sensing lines may form a radial shape disposed along the circular extension direction of the first sensing lines.

The touch portion may further include an insulating layer covering the first and second sensing lines.

The first sensing line may include a first crossing portion, a first connection line, and a second connection line. The first crossing portion may correspond to a portion in which the first sensing line crosses the second sensing line. The first connection line may be connected with one end of the first crossing portion. The second connection line may be connected with the other end of the first crossing portion.

The second sensing line may include a second crossing portion, a third connection line, and a fourth connection line. The second crossing portion may correspond to a portion in which the second sensing line crosses the first sensing line. The third connection line may be connected with one end of the second crossing portion. The fourth connection line may be connected with another end of the second crossing portion.

A transmission signal may be applied to the first sensing line and a receiving signal may be applied to the second sensing line.

A receiving signal may be applied to the first sensing line and a transmission signal may be applied to the second sensing line.

The first sensing line may be extended in an oval shape.

According to an exemplary embodiment of the present invention, a touch sensor is provided. The touch sensor includes a substrate and a touch portion. The touch portion is disposed on the substrate and configured to recognize a fingerprint. The touch portion includes first sensing lines and second sensing lines crossing the first sensing lines. A portion of the first sensing lines is curved. The second sensing lines are extended in a straight line outwardly from the center of the touch portion. Cross portions in which the first and second sensing lines cross each other are more densely disposed toward the center of the touch portion.

The curved portion of the first sensing lines may be a segment of a circle.

The curved portion of the first sensing lines may be a segment of an oval.

A transmission signal may be applied to the first sensing lines and a receiving signal may be applied to the second sensing lines.

A receiving signal may be applied to the first sensing lines and a transmission signal may be applied to the second sensing lines.

The first sensing lines may be separated from each other. The first sensing lines may form concentric circles.

The second sensing lines may be separated from each other. The second sensing lines may form a radial shape disposed along the circular extension direction of the first sensing lines.

The touch sensor may include a first insulating layer and a second insulating layer. The first insulating layer may be disposed on the substrate and the second insulating layer may be disposed on the first insulating layer covering the first and second sensing lines. The first sensing line may include a first crossing portion, a first connection line, and a second connection line. The first crossing portion may correspond to a portion in which the first sensing line crosses the second sensing line. The first connection line may be connected with one end of the first crossing portion. The second connection line may be connected with another end of the first crossing portion. The first crossing portion, the first connection line, and the second connection line may be disposed on the first insulating layer. The second connection line may have a shape that is progressively larger toward to an outer side of the first crossing portion.

According to an exemplary embodiment of the present invention, a touch sensor is provided. The touch sensor includes a substrate and a touch portion. The touch portion is disposed on the substrate and configured to recognize a fingerprint. The touch portion includes a first sensing line and a second sensing line crossing the first sensing line. A portion of the first sensing line is curved and the second sensing line is extended in a straight line outwardly from the center of the touch portion. One side of the touch portion is connected to a flexible printed circuit board which is connected to a driving circuit.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a top plan view of a touch sensor according to an exemplary embodiment of the present invention;

FIG. 2 is a top plan view of a touch portion of FIG. 1 according to an exemplary embodiment of the present invention;

FIG. 3 is a top plan view of part A in FIG. 2 according to an exemplary embodiment of the present invention;

FIG. 4 is a cross-sectional view of FIG. 3, taken along the line IV-IV according to an exemplary embodiment of the present invention;

FIG. 5 is a top plan view of a touch portion of a touch sensor according to an exemplary embodiment of the present invention;

FIG. 6 is a top plan view of a touch portion of a touch sensor according to an exemplary embodiment of the present invention; and

FIG. 7 is a top plan view of a touch portion of a touch sensor according to an exemplary embodiment of the present invention.

### DETAILED DESCRIPTION OF THE DRAWINGS

The present invention will be described more fully hereinafter with reference to the accompanying drawings, in which exemplary embodiments of the present invention are shown. However, the present invention may be embodied in various forms without departing from the spirit or scope of the present invention.

The drawings and description are to be regarded as illustrative in nature and not restrictive, and like reference numerals may designate like elements throughout the specification.

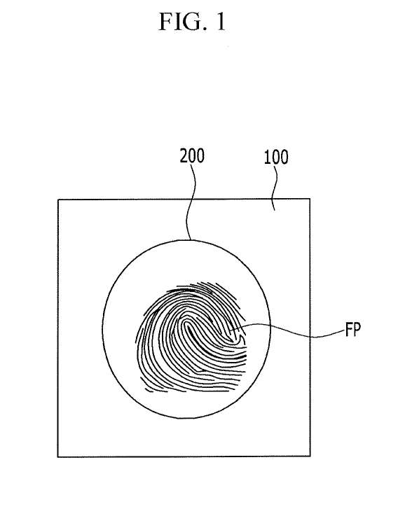

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. Hereinafter, a touch sensor according to an exemplary embodiment of the present invention will be described with reference to FIG. 1 to FIG. 4.

FIG. 1 is a top plan view of a touch sensor according to an exemplary embodiment of the present invention.

As shown in FIG. 1, a touch sensor according to an exemplary embodiment of the present invention includes a substrate 100 and a touch portion 200 provided on the substrate 100.

The substrate 100 is formed as a transparent insulating substrate including glass, quartz, ceramic, or the like. However, an exemplary embodiment of the present invention is not limited thereto, and, for example, the substrate 100 may be formed as a metallic substrate including stainless steel, or the like. In addition, when the substrate 100 includes a film such as plastic, or the like, the touch sensor may be flexible, stretchable, and/or rollable.

The touch portion 200 is provided on the substrate 100, and the touch portion 200 is formed in a circular shape for recognition of a fingerprint FP (e.g., a user's fingerprint). The touch portion 200 may be a capacitive type, but an embodiment of the present invention is not limited thereto. A flexible printed circuit board (not shown) may be connected to one side of the touch portion 200. The flexible printed circuit board may be connected with a driving circuit (not shown) for detecting a touch input location.

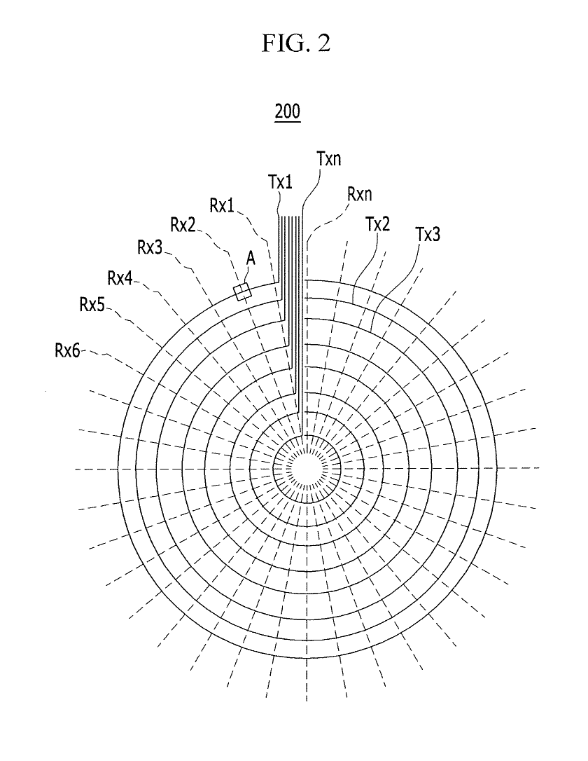

FIG. 2 is a top plan view of the touch portion of FIG. 1 according to an exemplary embodiment of the present invention.

As shown in FIG. 2, the touch portion 200 includes a plurality of first sensing lines Tx1 to Txn and a plurality of second sensing lines Rx1 to Rxn.

The first sensing lines Tx1 to Txn are circularly extended. For example, the first sensing lines Tx1 to Txn are linearly extended from an outer edge of the touch portion 200 and circularly extended at an inner side of the touch portion 200. The first sensing lines Tx1 to Txn are separated from each other and form circles of which the sizes are gradually decreased to the center from the outer edge of the touch portion 200 (e.g., concentric circles). For example, among two neighboring first sensing lines Tx1 and Tx2, one first sensing line Tx2 located at an inner side of the center forms a circle that is smaller than a circle formed by the other first sensing line Tx1 located at an outer side of the center.

The second sensing lines Rx1 to Rxn are linearly extended. For example, the second sensing lines Rx1 to Rxn are linearly extended in the outer side direction from the center of the touch portion 200 and cross the circularly extended first sensing lines Tx1. The second sensing lines Rx1 to Rxn are separated from each other and arranged along the extension direction of the first sensing lines Tx1 to Txn such that a radial shape is formed. For example, among neighboring second sensing lines Rx1 and Rx2, one second sensing line Rx1 and the other second sensing line Rx2 disposed at the side of the second sensing line Rx1 are respectively arranged along the extension direction of the first sensing lines Tx1 to Txn such that the respective two second sensing lines Rx1 and Rx2 form a radial shape.

A transmission signal may be applied to the first sensing lines Tx1 to Txn and a receiving signal may be applied to the second sensing lines Rx1 to Rxn. For example, when the touch portion 200 recognizes a fingerprint FP, a variation in capacitance between the first sensing lines Tx1 to Txn and the second sensing lines Rx1 to Rxn may be transmitted to the driving circuit through the second sensing lines Rx1 to Rxn.

In such a touch sensor, voltages are sequentially applied to the plurality of first sensing lines Tx1 to Txn and the plurality of second sensing lines Rx1 to Rxn, and thus, capacitances are charged respectively between the first and second sensing lines Tx1 to Txn and Rx1 to Rxn. In this case, for example, when a touch is performed by the fingerprint FP (e.g., an end of the fingerprint) to the first sensing lines Tx1 to Txn or the second sensing lines Rx1 to Rxn, capacitances are changed between the first sensing lines Tx1 to Txn and the second sensing lines Rx1 to Rxn where the touch is performed. Thus, a receiving signal corresponding to the variation in capacitances is transmitted through the second sensing lines Rx1 to Rxn so that the touch sensor may recognize the fingerprint FP.

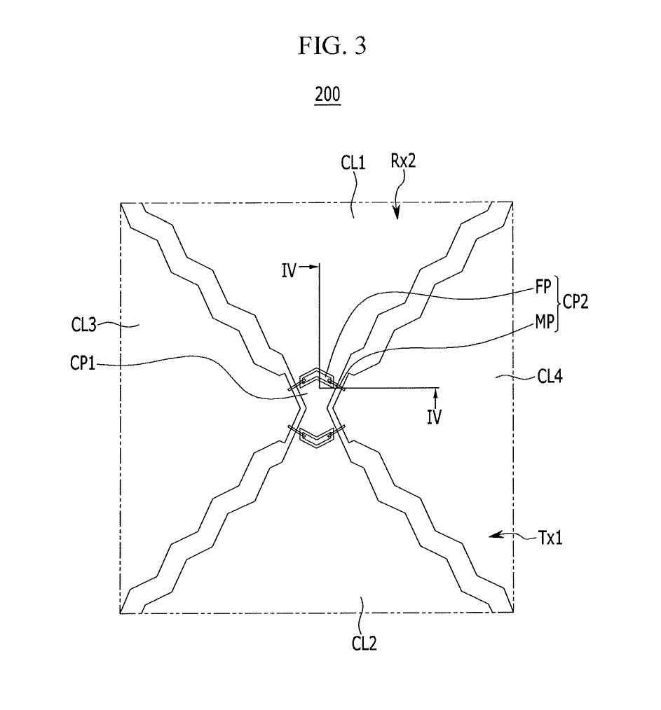

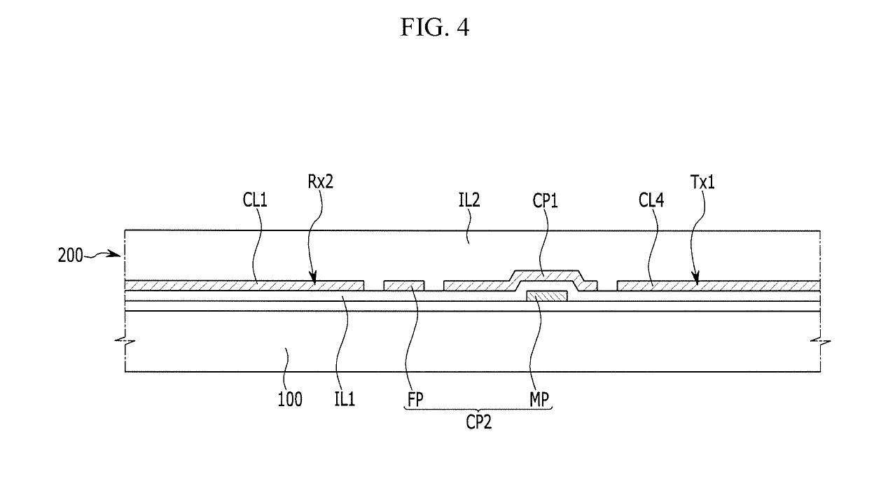

As used herein, the phrase “recognize the fingerprint FP” may be used to describe a process by which a particular unique fingerprint of a user is correctly identified. Hereinafter, the touch portion 200 of the touch sensor according to the exemplary embodiment of the present invention will be described with reference to FIG. 3 and FIG. 4.

FIG. 3 is a top plan view of part A of FIG. 2. FIG. 4 is a cross-sectional view of FIG. 3, taken along the line IV-IV.

As shown in FIG. 3 and FIG. 4, the touch portion 200 includes a first insulating layer IL1, the first sensing lines Tx1 to Txn, the second sensing lines Rx1 to Rxn, and a second insulating layer IL2 which are provided on the substrate 100.

The first insulating layer IL1 may include a silicon oxide (SiOx), a silicon nitride (SiNx), or the like.

The second sensing lines Rx1 to Rxn include a first crossing portion CP1, a first connection line CL1, and a second connection line CL2. For example, each of the second sensing lines Rx1 to Rxn may include a first crossing portion CP1, a first connection line CL1, and a second connection line CL2.The first crossing portion CP1 is provided on the first insulating layer IL1 corresponding to a portion crossing the first sensing lines Tx1 to Txn. For example, the first crossing portion CP1 may correspond to a portion crossing one of the first sensing lines Tx1 to Txn.

The first connection line CL1 is connected with one end of the first crossing portion CP1 and is extended therefrom. The first connection line CL1 has a shape that is larger toward one outer side from the first crossing portion CP1. The first connection line CL1 is provided on the first insulating layer IL1 and is of the same layer as the first crossing portion CP1.

The second connection line CL2 is connected with the other end of the first crossing portion CP1 and is extended therefrom. The second connection line CL2 has a shape that is larger toward the other outer side from the first crossing portion CP1. The second connection line CL2 is provided on the first insulating layer IL1 and is of the same layer as the first crossing portion CP1 and the first connection line CL1.

The first crossing portion CP1, the first connection line CL1, and the second connection line CL2 may be integrally formed, and may include a light transmissive conductive material such as indium tin oxide, indium zinc oxide, or the like. For example, the first crossing portion CP1, the first connection line CL1, and the second connection line CL2 may be formed through one process.

The first sensing lines Tx1 to Txn include a second crossing portion CP2, a third connection line CL3, and a fourth connection line CL4. For example, each of the first sensing lines Tx1 to Txn may include a second crossing portion CP2, a third connection line CL3, and a fourth connection line CL4.

The second crossing portion CP2 is provided on the substrate 100 corresponding to a portion that crosses the second sensing lines Rx1 to Rxn. For example, the second crossing portion CP2 may correspond to a portion crossing one of the second sensing lines Rx1 to Rxn. The second crossing portion CP2 includes a connection portion MP and a floating portion FP.

The connection portion MP is provided between the substrate 100 and the first insulating layer IL1, and connects between the third connection line CL3 and the floating portion FP and between the fourth connection line CL4 and the floating portion FP. The connection portion MP may include a conductive material such as a metal, or the like.

The floating portion FP neighbors the first crossing portion CP1, and is floated at a distance from the first crossing portion CP1. The floating portion FP connects between the third connection line CL3 and the fourth connection line CL4 through the connection portion MP. The floating portion FP is provided on the same layer as the first crossing portion CP1, the first connection line CL1, the second connection line CL2, the third connection line CL3, and the fourth connection line CL4.

The third connection line CL3 is connected with one end of the second crossing portion CP2 and extended therefrom. The third connection line CL3 has a shape that is enlarges toward one outer side from the second crossing portion CP2. The third connection line CL3 is provided on the first insulating layer IL1 and is of the same layer as the floating portion FP of the second crossing portion CP2 and the fourth connection line CL4.

The fourth connection line CL4 is connected with the other end of the second crossing portion CP2 and extended therefrom. The fourth connection line CL4 has a shape that is enlarges toward the other outer side from the second crossing portion CP2. The fourth connection line CL4 is provided on the first insulating layer IL1 and is of the same layer as the floating portion FP of the second crossing portion CP2 and the third connection line CL3.

The floating portion FP of the second crossing portion CP2, the third connection line CL3, the fourth connection line CL4, the first crossing portion CP1, the first connection line CL1, and the second connection line CL2 may be provided on the same layer, and may include a common light transmissive conductive material such as indium tin oxide, indium zinc oxide, or the like. For example, the floating portion FP of the second crossing portion CP2, the third connection line CL3, the fourth connection line CL4, the first crossing portion CP1, the first connection line CL1, and the second connection line CL2 may be formed through one process. However, the present invention is not restrictive thereto. In an exemplary embodiment of the present invention, the second crossing portion CP2 may be formed through a process that is different from the process of forming the third connection line CL3, the fourth connection line CL4, the first crossing portion CP1, the first connection line CL1, and the second connection line CL2. In this case, the second crossing portion CP2 may be wholly overlapped with the first crossing portion CP1.

The second insulating layer IL2 covers the first sensing lines Tx1 to Txn and the second sensing lines Rx1 to Rxn, and may include a silicon oxide (SiOx), a silicon nitride (SiNx), or the like.

As described above, the touch portion 200 of the touch sensor according to an exemplary embodiment of the present invention includes the plurality of circularly extended first sensing lines Tx1 to Txn and the plurality of linearly extended second sensing lines Rx1 to Rxn, and thus, an amount of crossing portions of neighboring first sensing lines Tx1 to Txn and second sensing lines Rx1 to Rxn increases toward the center of the touch portion 200 from the outer side, for example, the crossing portions of the neighboring first sensing lines Tx1 to Txn and second sensing lines Rx1 to Rxn may be more densely positioned. A fingerprint FP has a shape in which an amount of complexity increases toward the center from the outer side. In addition, in a touch sensor according to an exemplary embodiment of the present invention, an amount of the crossing portions where the first sensing lines Tx1 to Txn and the second sensing lines Rx1 to Rxn cross each other increases toward the center of the touch portion 200 from the outer side, and thus, the shape of the fingerprint FP may be recognized without increasing the numbers of first sensing lines Tx1 to Txn and second sensing lines Rx1 to Rxn.

For example, corresponding to the shape of fingerprint FP, the touch sensor includes the circular-shaped touch portion 200 including the plurality of first sensing lines Tx1 to Txn and the plurality of plurality of second sensing lines Rx1 to Rxn, and thus, the shape of fingerprint FP may be recognized.

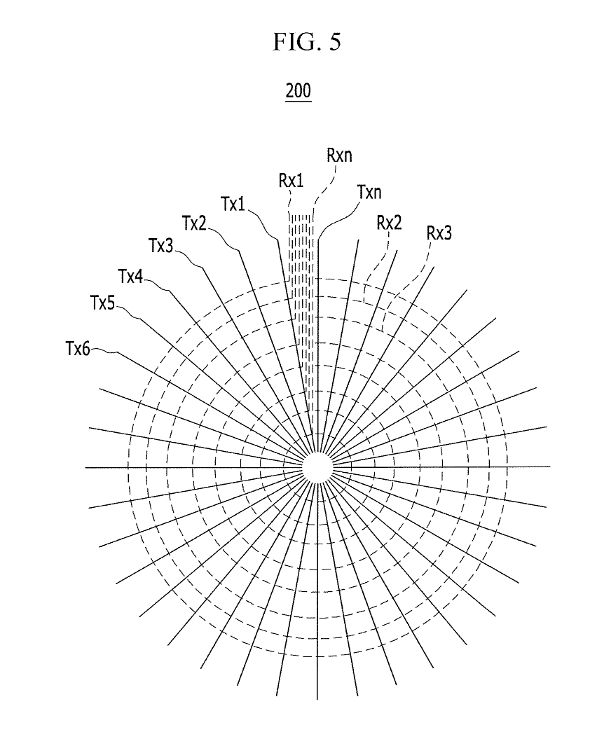

Hereinafter, a touch sensor according to an exemplary embodiment of the present invention will be described with reference to FIG. 5.

FIG. 5 is a top plan view of a touch portion of a touch sensor according to an exemplary embodiment of the present invention.

As shown in FIG. 5, in a touch sensor according to an exemplary embodiment of the present invention, a plurality of first sensing lines Rx1 to Rxn may receive a receiving signal and a plurality of second sensing lines Tx1 to Txn may receive a transmission signal. For example, when a touch portion 200 recognizes a fingerprint FP, a variation in capacitance between the first sensing lines Rx1 to Rxn and the second sensing lines Tx1 to Txn may be transmitted to a driving circuit through the first sensing lines Rx1 to Rxn.

As described above, the touch sensor according to an exemplary embodiment of the present invention includes a plurality of sensing lines Rx1 to Rxn that are circularly extended and a plurality of second sensing lines Tx1 to Txn that are linearly extended, and thus, an amount of crossing portions where the first and second sensing lines Rx1 to Rxn and Tx1 to Txn cross each other increases toward the center of the touch portion 200 from the outer side. For example, a fingerprint FP has a shape in which an amount of complexity increases toward the center from the outer side. In addition, corresponding to the shape of fingerprint FP, a capacitive-type touch sensor may include sensing lines that are respectively arranged with a narrow gap in a narrow area so as to recognize the fingerprint FP. In addition, in the touch portion 200 of the touch sensor according to the exemplary embodiment of the present invention, an amount of crossing portions where the first and second sensing lines Rx1 to Rxn and Tx1 to Txn cross each other increases toward the center of the touch portion 200 from the outer side. This characteristic may correspond to the shape of the fingerprint FP, and thus, the shape of the fingerprint FP may be recognized without increasing the numbers of first sensing lines Rx1 to Rxn and second sensing lines Tx1 to Txn.

For example, corresponding to the fingerprint FP, the touch sensor includes the circular-shaped touch portion 200 including the plurality of first sensing lines Tx1 to Txn and the plurality of second sensing lines Rx1 to Rxn, and thus, the fingerprint FP may be recognized.

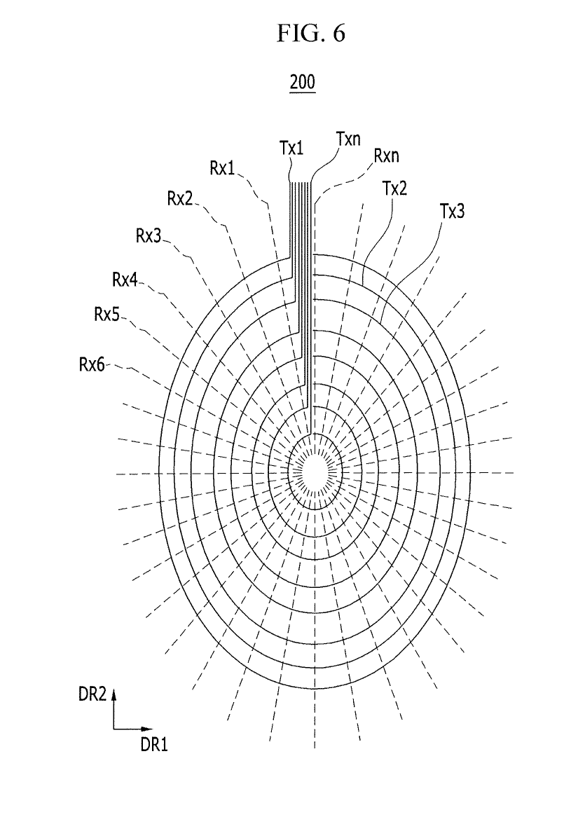

Hereinafter, a touch sensor according to an exemplary embodiment of the present invention will be described with reference to FIG. 6.

FIG. 6 is a top plan view of a touch portion of a touch sensor according to an exemplary embodiment of the present invention.

As shown in FIG. 6, a touch sensor according to an exemplary embodiment of the present invention includes an oval-shaped touch portion 200. The touch sensor according to the exemplary embodiment of the present invention includes a plurality of first sensing lines Tx1 to Txn that are extended in the shape of an oval that is relatively long in a vertical direction DR2 and relatively short in a horizontal direction DR1.

As described above, the touch sensor having the oval-shaped touch portion 200 illustrated in FIG. 6 may better recognize a fingerprint FP than other touch sensors having touch portions, for example, illustrated in FIGS. 2, 5, and 7 in an area that is relatively long in the vertical direction DR2 and relatively short in the horizontal direction DR1.

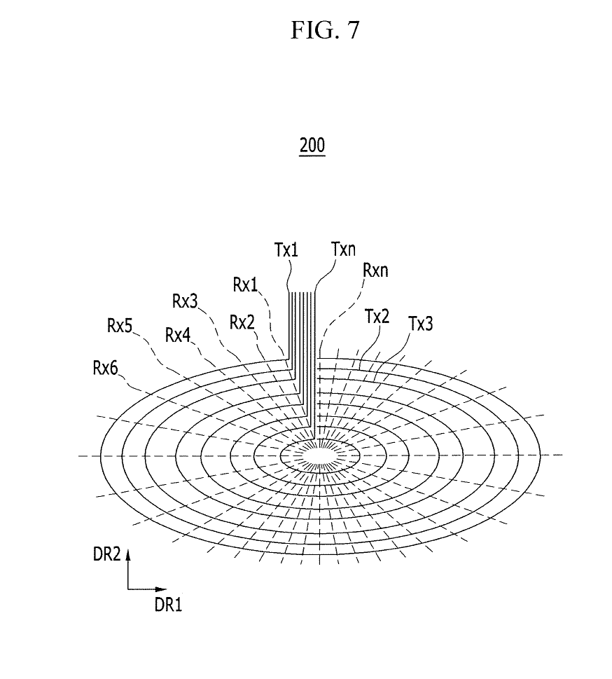

Hereinafter, a touch sensor according to an exemplary embodiment of the present invention will be described with reference to FIG. 7.

FIG. 7 is a top plan view of a touch portion of a touch sensor according to an exemplary embodiment of the present invention.

As shown in FIG. 7, a touch sensor according to an exemplary embodiment of the present invention includes an oval-shaped touch portion 200. The touch sensor according to an exemplary embodiment of the present invention includes a plurality of first sensing lines Tx1 to Txn that are extended in the shape of an oval that is relatively long in a horizontal direction DR1 and relatively short in a vertical direction DR2.

As described above, the touch sensor having the oval-shaped touch portion 200 illustrated in FIG. 7 may better recognize a fingerprint FP than other touch sensors having touch portions, for example, illustrated in FIGS. 2, 5, and 6 in an area that is relatively long in the horizontal direction DR1 and relatively short in the vertical direction DR2.

While the present invention has been described with reference to exemplary embodiments thereof, it will be understood that the present invention is not limited to the disclosed embodiments.

What is claimed is:

1. A touch sensor comprising:
a substrate; and
a circular-shaped touch portion provided on the substrate, and including a plurality of sensing lines,
wherein cross portions in which the plurality of sensing lines crosses each other are more densely disposed towards the center of the touch portion, and
wherein the touch portion is configured to recognize a fingerprint.

2. The touch sensor of claim 1, wherein the plurality of sensing lines comprises
a circularly extended first sensing line, and
a second sensing line linearly extended in an outer direction from the center of the touch portion, wherein the second sensing line crosses the first sensing line.

3. The touch sensor of claim 1, wherein the first sensing line is linearly extended from an outer side of the touch portion and circularly extended at an inner side of the touch portion.

4. The touch sensor of claim 1, wherein the first sensing line is provided in plural, and the first sensing lines are separated from each other and form concentric circles.

5. The touch sensor of claim 2, wherein the second sensing line is provided in plural, and the second sensing lines are separated from each other, and
wherein the second sensing lines form a radial shape disposed along the circular extension direction of the first sensing line.

6. The touch sensor of claim 2, wherein the touch portion further comprises an insulating layer covering the first and second sensing lines.

7. The touch sensor of claim 2, wherein the first sensing line comprises:
a first crossing portion corresponding to a portion in which the first sensing line crosses the second sensing line;
a first connection line connected with one end of the first crossing portion; and
a second connection line connected with another end of the first crossing portion.

8. The touch sensor of claim 2, wherein the second sensing line comprises:
a second crossing portion corresponding to a portion in which the second sensing line crosses the first sensing line;
a third connection line connected with one end of the second crossing portion; and
a fourth connection line connected with the other end of the second crossing portion.

9. The touch sensor of claim 2, wherein a transmission signal is applied to the first sensing line and a receiving signal is applied to the second sensing line.

10. The touch sensor of claim 2, wherein a receiving signal is applied to the first sensing line and a transmission signal is applied to the second sensing line.

11. The touch sensor of claim 1, wherein the first sensing line is extended in an oval shape.

12. A touch sensor comprising:
a substrate; and
a touch portion disposed on the substrate, the touch portion configured to recognize a fingerprint,
wherein the touch portion comprises first sensing lines and second sensing lines crossing the first sensing lines,
wherein a portion of the first sensing lines is curved and the second sensing lines are extended in a straight line outwardly from the center of the touch portion, and
wherein cross portions in which the first and second sensing lines cross each other are more densely disposed toward the center of the touch portion.

13. The touch sensor of claim 12, wherein the curved portion of the first sensing lines is a segment of a circle.

14. The touch sensor of claim 12, wherein the curved portion of the first sensing lines is a segment of an oval.

15. The touch sensor of claim 12, wherein a transmission signal is applied to the first sensing lines and a receiving signal is applied to the second sensing lines.

16. The touch sensor of claim 12, wherein a receiving signal is applied to the first sensing lines and a transmission signal is applied to the second sensing lines.

17. The touch sensor of claim 12, wherein the first sensing lines are separated from each other and form concentric circles.

18. The touch sensor of claim 17, wherein the second sensing lines are separated from each other and form a radial shape along the circular extension direction of the first sensing lines.

19. The touch sensor of claim 12, wherein the touch sensor comprises a first insulating layer disposed on the substrate and a second insulating layer disposed on the first insulating layer covering the first and second sensing lines,
wherein at least one of the first sensing lines includes a first crossing portion corresponding to a portion in which the at least one of first sensing lines crosses at least one of the second sensing lines, a first connection line connected with one end of the first crossing portion, and a second connection line connected with another end of the first crossing portion,
wherein the first crossing portion, the first connection line, and the second connection line are disposed on the first insulating layer, and
wherein the second connection line has a shape that is progressively larger toward an outer side of the first crossing portion.

20. A touch sensor comprising:
a substrate; and
a touch portion disposed on the substrate, the touch portion configured to recognize a fingerprint,
wherein the touch portion comprises a first sensing line and a second sensing line crossing the first sensing line,
wherein a portion of the first sensing line is curved and the second sensing line is extended in a straight line outwardly from the center of the touch portion, and
wherein one side of the touch portion is connected to a flexible printed circuit board which is connected to a driving circuit.
